(19) United States
(12) Patent Application Publication
(10) Pub. No.: US 2018/0288439 A1
(43) Pub. Date: Oct. 4, 2018

(54) Multiple Transform Prediction

(71) Applicant: MediaTek Inc., Hsinchu City (TW)

(72) Inventors: Chih-Wei Hsu, Hsinchu City (TW); Man-Shu Chiang, Hsinchu City (TW)

(21) Appl. No.: 15/928,092

(22) Filed: Mar. 22, 2018

Related U.S. Application Data
(60) Provisional application No. 62/479,351, filed on Mar. 31, 2017.
(60) Provisional application No. 62/480,253, filed on Mar. 31, 2017.

(51) Int. Cl. H04N 19/61; H04N 19/625; H04N 19/176; H04N 19/182; H04N 19/91; H04N 19/70

(52) U.S. Cl. CPC H04N 19/61; H04N 19/625; H04N 19/70; H04N 19/182; H04N 19/91; H04N 19/176

(57) ABSTRACT

An efficient signaling method for multiple transforms to further improve coding performance is provided. Rather than using code words that are assigned to different transforms in a predetermined and fixed manner, different transform modes are mapped into different code words dynamically. A predetermined procedure is used to assign the code words to the different transform modes. A cost is computed for each candidate transform mode and the transform mode with the smallest cost is chosen as the predicted transform mode, and the chosen predicted transform mode is assigned the shortest code word.

CROSS REFERENCE TO RELATED PATENT APPLICATION(S)

The present disclosure is part of a non-provisional application that claims the priority benefit of U.S. Provisional Patent Application No. 62/479,351, filed on 31 Mar. 2017 and U.S. Provisional Patent Application No. 62/480,253, filed on 31 Mar. 2017. Contents of above-listed application are herein incorporated by reference.

### TECHNICAL FIELD

The present disclosure relates generally to video processing. In particular, the present disclosure relates to signaling selection of transform operations.

### BACKGROUND

Unless otherwise indicated herein, approaches described in this section are not prior art to the claims listed below and are not admitted as prior art by inclusion in this section.

High-Efficiency Video Coding (HEVC) is a new international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block, and each CU can be recursively split into four smaller CUs until the predefined minimum size is reached. Each CU contains one or multiple prediction units (PUs). After prediction, one CU is further split into transform units (TUs) for transform and quantization.

Like many other precedent standards, HEVC adopts Discrete Cosine Transform type II (DCT-II) as its core transform because it has a strong “energy compaction” property. Most of the signal information tends to be concentrated in a few low-frequency components of the DCT-II, which approximates the Karhunen-Loève Transform (KLT, which is optimal in the decorrelation sense) for signals based on certain limits of Markov processes. The N-point DCT-II of the signal f[n] is defined as:

$${\hat{f}}_{DCT - II} [ k ] = {λ}_{k} \frac{2}{\sqrt{N}} {\sum }_{n = 0}^{N - 1} f [ n ] cos [ \frac{k π}{N} ( n + \frac{1}{2} ) ] , \\ k = 0 , 1 , 2 , … , N - 1 , {λ}_{k} = \{ \begin{matrix}{2}^{- 0.5} , & k = 0 \\ 1 , & k \neq 0\end{matrix}$$

For intra-predicted residue, there are transforms other than DCT-II that can be used as core transform. In JCTVC-B024, JCTVC-C108, JCTVC-E125, Discrete Sine Transform (DST) was introduced to be used alternatively with DCT for oblique intra modes. For inter-predicted residue, DCT-II is the only transform used in current HEVC. However, the DCT-II is not the optimal transform for all cases. In JCTVC-G281, the Discrete Sine Transform type VII (DST-VII) and Discrete Cosine Transform type IV (DCT-IV) are proposed to replace DCT-II in some cases. Also in JVET-D1001, an Adaptive Multiple Transform (AMT) scheme is used for residual coding for both intra and inter coded blocks. It utilizes multiple selected transforms from the DCT/DST families other than the current transforms in HEVC. The newly introduced transform matrices are DST-VII, DCT-VIII, DST-I and DCT-V. Table 1 summarizes the transform basis functions of each transform for N-point input.

TABLE 1
Transform basis functions for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ $where {ω}_{0} = \{ \begin{matrix}\sqrt{\frac{2}{N}} & i = 0 \\ 1 & i \neq 0\end{matrix}$ |
| DCT-V | ${T}_{i} ( j ) = {ω}_{0} \cdot {ω}_{1} \cdot \sqrt{\frac{2}{2 N - 1}} \cdot cos ( \frac{2 π \cdot i \cdot j}{2 N - 1} ) , \\ where ω = \{ \begin{matrix}\sqrt{\frac{2}{N}} & i = 0 \\ 1 & i \neq 0\end{matrix} , {ω}_{1} = \{ \begin{matrix}\sqrt{\frac{2}{N}} & j = 0 \\ 1 & j \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-I | ${T}_{i} ( j ) = \sqrt{\frac{2}{N + 1}} \cdot sin ( \frac{π \cdot ( i + 1 ) \cdot ( j + 1 )}{N + 1} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In addition to DCT transform as core transform for TUs, secondary transform is used to further compact the energy of the coefficients and to improve the coding efficiency. Such as in JVET-D1001, Non-separable transform based on Hypercube-Givens Transform (HyGT) is used as secondary transform, which is referred to as non-separable secondary transform (NSST). The basic elements of this orthogonal transform are Givens rotations, which are defined by orthogonal matrices G(m, n, θ), which have elements defined by:

$${G}_{i , j} ( m , n ) = \{ \begin{matrix}cos θ , & i = j = m or i = j = n , \\ sin θ , & i = m , j = n , \\ - sin θ , & i = n , j = m , \\ 1 , & i = j and i \neq m and i \neq n , \\ 0 , & otherwise .\end{matrix}$$

HyGT is implemented by combining sets of Givens rotations in a hypercube arrangement.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments provide a method for signaling the selection of a transform when encoding or decoding a block of pixels in a video picture. The encoder or decoder receives transform coefficients that are encoded by using a target transform mode that is selected from a plurality of candidate transform modes. The encoder or decoder computes a cost for each candidate transform mode and identifying a lowest cost candidate transform mode as a predicted transform mode. The encoder or decoder assigns code words of varying lengths to the plurality of candidate transform modes according to an ordering of the plurality of candidate transform modes. The predicted transform mode is assigned a shortest code word. The encoder or decoder identifies a candidate transform mode that matches the target transform mode and the corresponding code word assigned to the identified candidate transform mode.

In some embodiments, each transform mode in the plurality of candidate transform modes is a non-separable secondary transform (NSST) mode. In some embodiments, each transform mode in the plurality of candidate transform modes may be a core transform. In some embodiments, the block of pixels is coded into a set of transform coefficients by a particular intra-coding mode. The plurality of candidate transform modes are candidate transform modes that are mapped to the particular intra-coding modes. In some embodiments, the ordering of the plurality of candidate transform modes is based on the computed costs for the plurality of candidate transform modes. In some embodiments, the ordering of the plurality of candidate transform modes is based a predetermined table that specifies the ordering based on relationships to the predicted transform mode. The cost associated with each candidate transform mode may be computed by adaptively scaling or choosing transform coefficient of the block of pixels. The cost associated with each candidate transform mode may also be computed by adaptively scaling or choosing reconstructed residuals of the block of pixels. The cost associated with each candidate transform mode may be determined by computing a difference between pixels of the block and pixels in spatially neighboring blocks, wherein the pixels of the block are reconstructed from residuals of the block and predicted pixels of the block. In some embodiments, the transform coefficients associated with each candidate transform mode is adaptively scaled or chosen when reconstructing the residuals for the corresponding candidate transform mode. The reconstructed residuals of the block of pixels associated with each candidate transform mode is adaptively scaled or chosen when reconstructing the pixels for

the corresponding candidate transform mode. The set of pixels of the block being reconstructed includes pixels bordering the spatially neighboring blocks and not all pixels of the block. The cost associated with each candidate transform mode may be determined by measuring an energy of reconstructed residuals of the block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the correspondence between 68 intra prediction modes and 35 non-separable secondary transform (NSST) sets.

FIG. 2 illustrates an example NSST transform set and its corresponding code word generated by truncate unary coding.

FIG. 3 illustrates an example code word assignment for a NSST transform set that is based on costs associated with the different NSST modes of the transform set.

FIG. 4 illustrates the computation of cost for a transform unit (TU) based on correlation between reconstructed pixels of the current block for each candidate transform mode and reconstructed pixels of neighboring blocks.

FIG. 5 illustrates the computation of costs for a TU based on measuring the energy of the reconstructed residuals for each candidate transform mode.

FIG. 6 illustrates an example video encoder that uses dynamic code word assignment to signal selection of a transform from multiple candidate transforms.

FIG. 7 illustrates portions of the encoder that implements dynamic code word assignment for signaling selection from among multiple transforms.

FIG. 8 conceptually illustrates the cost analysis and code word assignment operations performed by the transform prediction module.

FIG. 9 conceptually illustrates a process that signals selection of a transform from multiple candidate transforms by using dynamic code word assignment.

FIG. 10 illustrates an example video decoder that uses dynamic code word assignment to receive selection of a transform from multiple candidate transforms.

FIG. 11 illustrates portions of the decoder that implement dynamic code word assignment for receiving a selection of the core transform and a selection of the secondary transform.

FIG. 12 conceptually illustrates the cost analysis and code word assignment operations performed for the transform code word decoding module.

FIG. 13 conceptually illustrates a process that uses dynamic code word assignment to receive selection of a transform from multiple candidate transforms.

FIG. 14 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

As more and more transforms are being introduced and used for coding, the signaling for multiple transforms becomes more complex, which may require higher bit rate. However, a multiple transform signaling scheme with higher compression efficiency may improve the overall coding performance.

Some embodiments of the disclosure provide an efficient signaling method for multiple transforms to further improve coding performance. Rather than using code words that are assigned to different transforms in a predetermined and fixed manner, the method maps different transform modes into different code words dynamically (a transform mode may be a specified transform or no transform at all). In some embodiments, the method uses a predetermined procedure to assign the code words to the different transform modes. In the procedure, a cost is computed for each candidate transform mode and the transform mode with the smallest cost is chosen as the predicted transform mode, and the chosen predicted transform mode is assigned the shortest code word.

In some embodiments, each transform mode in the plurality of candidate transform modes is a core transform that may be a type of DCT or DST. In some embodiments, each transform mode in the plurality of candidate transform modes is a non-separable secondary transform (NSST) mode.

In JEM-4.0 (the reference software for JVET), there are 35×3 non-separable secondary transforms (NSST) for both 4×4 and 8×8 TU sizes, where 35 is the number of transform sets specified by the intra prediction mode, and 3 is the number of candidate secondary transforms available for each Intra prediction mode. NSST is based on Hypercube-Givens Transform (HyGT). The basic elements of this orthogonal transform are Givens rotations. Three candidates transforms for each Intra prediction mode can be viewed as different rotation angles (θ) of NSST for the Intra prediction mode.

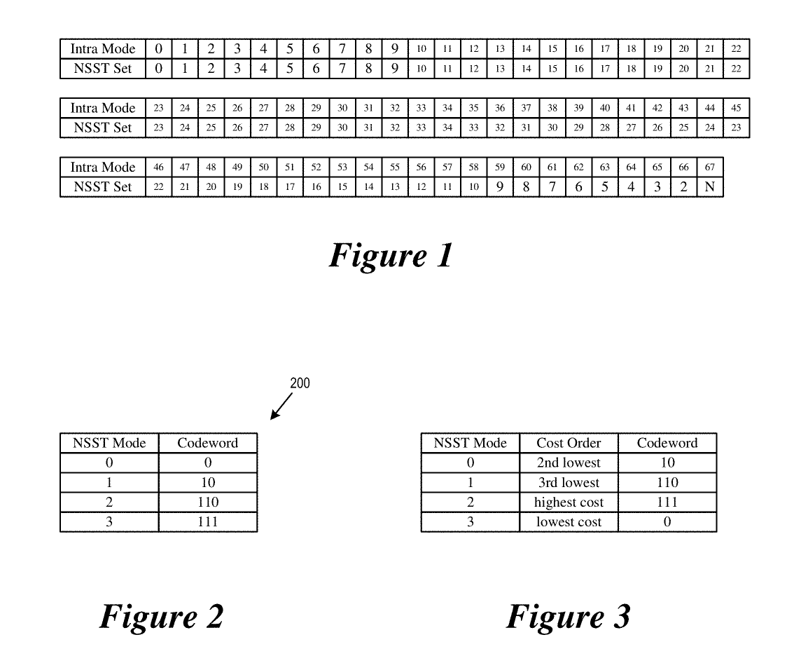

FIG. 1 shows the correspondence between 68 intra prediction modes and 35 NSST transform sets. Thus, for example, a block of pixels that is intra coded by intra mode 48 would use NSST transform set 20 for secondary transform. Though not illustrated in FIG. 1, the block of pixels may use any one or none of the 3 possible transforms of the NSST transform set 20 for secondary transform. A block of pixels can be a coding unit (CU), a transform unit (TU), a macro block, or any rectangular array of pixels that are coded as a unit.

FIG. 2 illustrates an example NSST transform set 200 and its corresponding code word based on truncated unary coding. This example NSST transform set can be any of the 35 NSST transform sets. The transform set 200 can have four modes that correspond to selection of one or none of the transforms in the set 200. Each mode is associated with an index that indicates which secondary transform to be used, such that the four modes are indexed ‘0’ through ‘3’. The NSST mode ‘0’ corresponds no NSST transform. The NSST mode ‘1’ corresponds to the first NSST transform of the set 200. The NSST mode ‘2’ corresponds to the second NSST transform of the set 200. The NSST mode ‘3’ corresponds to the third NSST transform of the set 200. Each NSST mode is also mapped to a code word. In this example, the NSST modes are assigned code words based on truncate unary coding. Specifically, the NSST mode ‘0’ is mapped to the shortest code word ‘0’, while the NSST mode ‘1’, ‘2’, and ‘3’ are mapped to longer code words ‘10’, ‘110’, ‘111’, respectively.

FIG. 3 illustrates an example code word assignment for a NSST transform set that is based on costs associated with the different NSST modes of the transform set. In this example, the NSST mode ‘3’ has the lowest cost so it is assigned the shortest code word “0”. The NSST mode ‘3’ is therefore also chosen as the predicted secondary transform. The NSST mode ‘0’ has the second lowest cost so it is assigned the second shortest code word “10”. The NSST modes ‘1’ and ‘2’ have the two highest costs so they are assigned the two longest code words “110” and “111”, respectively. In sum, the different NSST modes are assigned code words of different lengths in an order determined by their respective costs.

FIGS. 2 and 3 illustrates assignment of code words of different lengths to different secondary transforms by ordering different secondary transform modes according to costs. In some embodiments, code words of different lengths may be assigned to candidate transform modes of other types. Specifically, in some embodiments, code words of different lengths are assigned to different core transform modes by ordering the core transform modes according to costs. For example. In some embodiments, for each intra-coded block, the costs for the different possible core transforms (e.g., DCT-II, DCT-V, DCT-VIII, DST-I, and DST-VII) are computed, and the core transform with the lowest cost is chosen as the predicted core transform and assigned the shortest code word.

In some embodiments, the scheme of assigning code words based on computed costs apply to only a subset of the candidate transform modes. In other words, one or more of the candidate transform modes are assigned fixed code words regardless of costs, while the remaining candidate transform modes are dynamically assigned code words based on costs associated with the candidate transform modes.

Generally, an order is created for the transforms in the set and the code words are assigned according to that order. Furthermore, the shorter code words are assigned to the transforms near the front of the order while longer code words are given to transforms near the end of the order.

There are several methods of assigning code words to different possible transforms. In some embodiments, a predetermined table is used to specify the ordering related to the chosen predicted transform. For example, if the predicted transform is a secondary transform based on a specific rotation angle, then secondary transforms based nearby rotation angles are positioned near the front of the ordering while secondary transforms based on far rotation angles are positioned toward the end of the ordering. In some embodiments, the ordering is created based on costs as described above by reference to FIG. 3, where the lowest cost transform is chosen as the predicted transform and assigned the shortest code word.

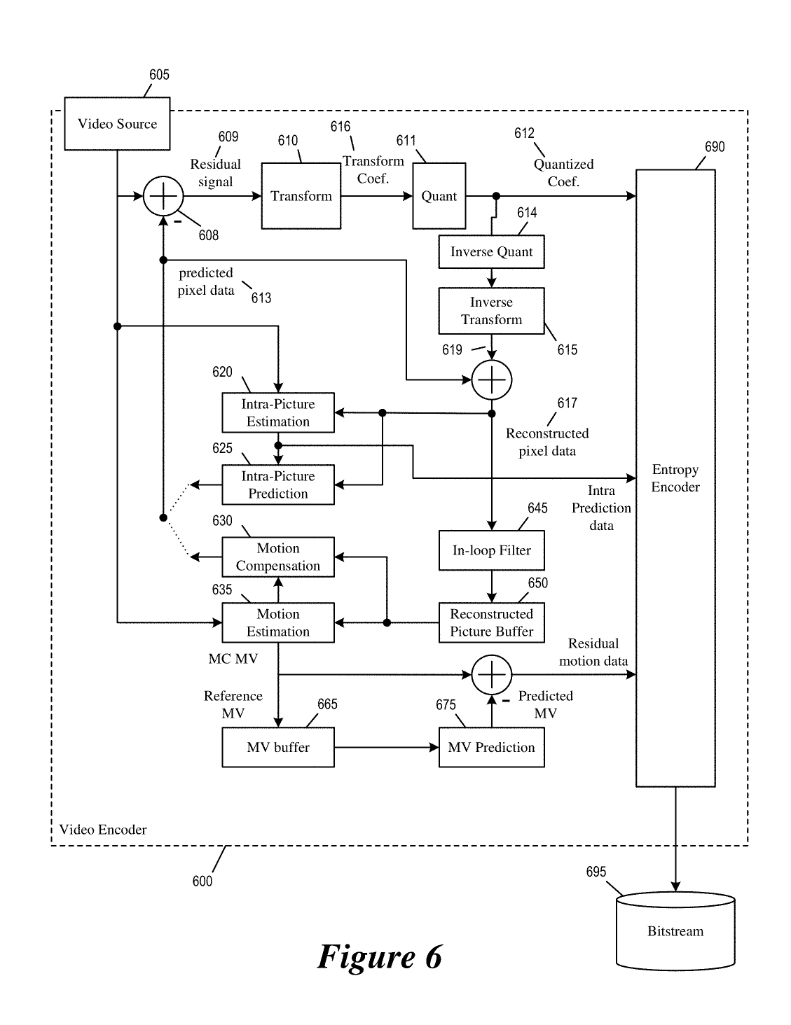

After a predicted transform mode is determined and all other transform modes are also mapped into an ordering or ordered list, the encoder may signal a target transform by comparing the target transform with the predicted transform. The target transform is the transform that is selected by the encoder or the coding process to encode the block of pixels for transmission or storage. If the target transform happens to be the predicted transform, the code word for the predicted transform (always the shortest one) can be used for the signaling. If that is not the case, the encoder can further search the ordered list to locate the position of the target transform in the ordering and the corresponding code word. An example encoder that uses dynamic code word to signal transform selection will be described by reference to FIGS. 6-8 below.

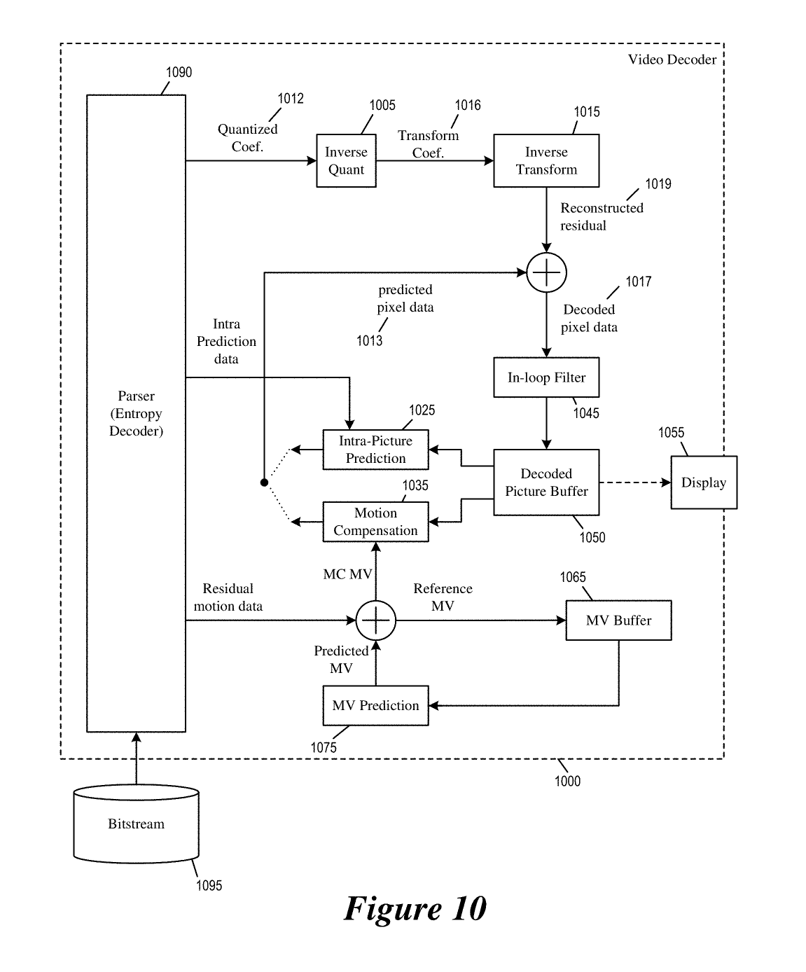

At the decoder, the same cost computation is performed for the various transforms in the transform set, based on which the same predicted transform is identified and the same ordered list is created. If the decoder receives the code word of the predicted transform, the decoder would know that the target transform is the predicted transform. If that is not the case, the decoder may look up the code word in the ordered list to identify the target transform. If the prediction is successful (e.g., the hit rate for the predicted transform is high so that the shortest code word is very frequently used), the signaling of the selection of the transform can be coded using fewer bits than without the predicted ordering. An example decoder that receives dynamic code word to select a transform will be described by reference to FIG. 10-12 below.

Different methods can be used to calculate the costs of multiple transforms. The cost of a particular transform is computed from reconstructed pixels or reconstructed residuals of the current block when the particular transform is applied. Quantized transform coefficients (or TU coefficients) of the current block (produced by the core and/or secondary transform) are de-quantized and then inverse transformed (by the inverse secondary and/or core transform) to generate the reconstructed residuals. (Residuals refer to the difference in pixel values between source pixel values of the block and the predicted pixel values of the block generated by intra or inter prediction; and reconstructed residuals are residuals reconstructed from transform coefficients.) By adding the reconstructed residuals of the block with predictors or predicted pixels generated by intra or inter prediction for the block, the reconstructed pixels of the current block can be reconstructed. (The reconstructed pixels of the current block are referred to as one hypothesis reconstruction for that particular core or secondary transform for some embodiments.)

In some embodiments, a boundary-matching method is used to compute the costs. Assuming the reconstructed pixels are highly correlated to the reconstructed neighboring pixels, a cost for a particular transform mode can be computed by measuring boundary similarity.

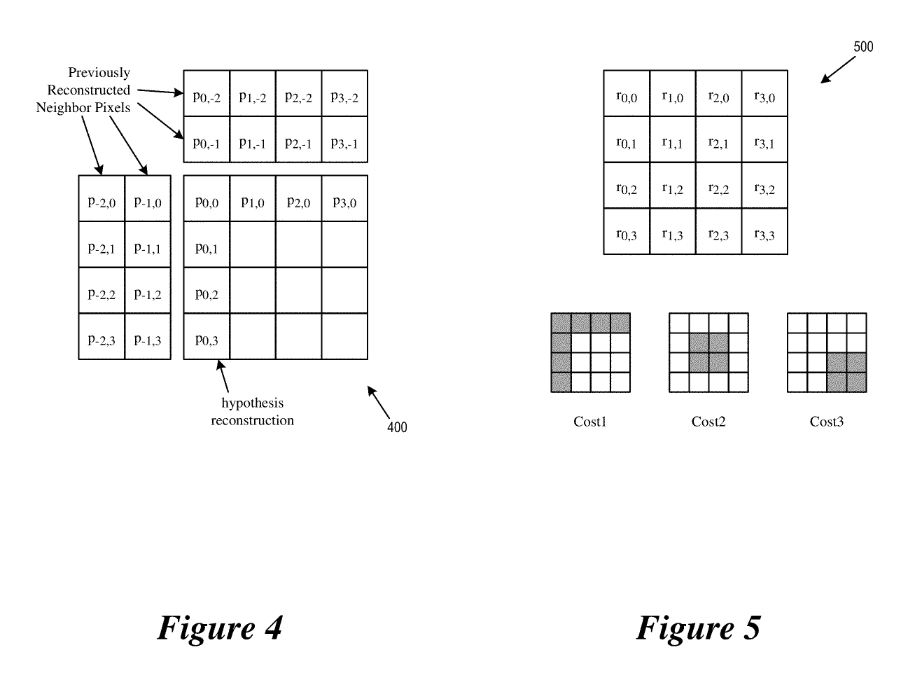

FIG. 4 illustrates the computation of cost for a TU 400 based on correlation between reconstructed pixels of the current block and reconstructed pixels of neighboring blocks (each pixel value of the block is denoted by p). For the TU 400, one hypothesis reconstruction is generated for one particular (core or secondary) transform. In some embodiments, the cost associated with the hypothesis reconstruction is calculated as:

$$cost = {\sum }_{x = 0}^{w - 1} \vert ( 2 {p}_{x , - 1} - {p}_{x , - 2} ) - {p}_{x , 0} \vert + {\sum }_{y = 0}^{h - 1} \vert ( 2 {p}_{- 1 , y} - {p}_{- 2 , y} ) - {p}_{0 , y} \vert$$

This cost is computed based on pixels along the top and left boundaries (boundaries with previously reconstructed blocks) of the TU. In this boundary matching process, only the border pixels are reconstructed. In some embodiments, the inverse secondary transform can be omitted for complexity reduction when reconstructing pixels for cost computation of different core transforms. In some embodiments, the transform coefficients can be adaptively scaled or chosen when reconstructing the residuals. In some embodiments, the reconstructed residuals can be adaptively scaled or chosen when reconstructing the pixels of the block. In some embodiments, different numbers of boundary pixels or different shapes of boundary (e.g., only top, only above, only left, or other extension) are used to calculate the costs. In some embodiments, different cost functions can be used to measure the boundary similarity. For example, in some embodiments, the boundary matching cost function may factor in the direction of the corresponding intra prediction mode for the secondary transform for which the cost is calculated.

In some embodiments, rather than performing boundary matching based on reconstructed pixels, the cost is computed based on the features of the reconstructed residuals, e.g., by measuring the energy of the reconstructed residuals. FIG. 5 illustrates the computation of costs for a TU 500 based on measuring the energy of the reconstructed residuals. (Each residual at a pixel location is denoted as r.) The cost of a particular transform is calculated as the sum of absolute values of a chosen set of residuals that are reconstructed by using the transform.

Different sets (or different shapes) of residuals can be used to generate the cost in different embodiments. Cost1 is calculated as the sum of absolute values of residuals in the top row and the left, specifically:

cost1=Σₓ₌₀^{w-1}|r_{x,0}|+Σ_{y=0}^{h-1}|r_{0,y}|

Cost2 is calculated as the sum of absolute values of the center region of the residuals, specifically:

$$cost 2 = {\sum }_{x = 1}^{w - 2} {\sum }_{y = 1}^{h - 2} \vert {r}_{x , y} \vert$$

Cost3 is calculated as the sum of absolute values of the bottom right corner region of the residuals, specifically:

$$cost 3 = {\sum }_{x = w / 2}^{w - 1} {\sum }_{y = h / 2}^{h - 1} \vert {r}_{x , y} \vert$$

### Example Video Encoder

FIG. 6 illustrates an example video encoder 600 that uses dynamic code word assignment to signal selection of a transform from multiple candidate transforms. As illustrated, the video encoder 600 receives input video signal from a video source 605 and encodes the signal into bitstream 695. The video encoder 600 has several components or modules for encoding the video signal 605, including a transform module 610, a quantization module 611, an inverse quantization module 614, an inverse transform module 615, an intra-picture estimation module 620, an intra-picture prediction module 625, a motion compensation module 630, a motion estimation module 635, an in-loop filter 645, a reconstructed picture buffer 650, a MV buffer 665, and a MV prediction module 675, and an entropy encoder 690.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from motion compensation 630 or intra-picture prediction 625. The transform 610 converts the difference (or the residual pixel data or residual signal 609) into transform coefficients (e.g., by performing Discrete Cosine Transform, or DCT). The quantizer 611 quantized the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the prediction pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-picture prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data. Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes parameters such as quantized transform data and residual motion data into the bitstream 690. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering operation performed includes sample adaptive offset (SAO). In some embodiment, the filtering operations include adaptive loop filter (ALF).

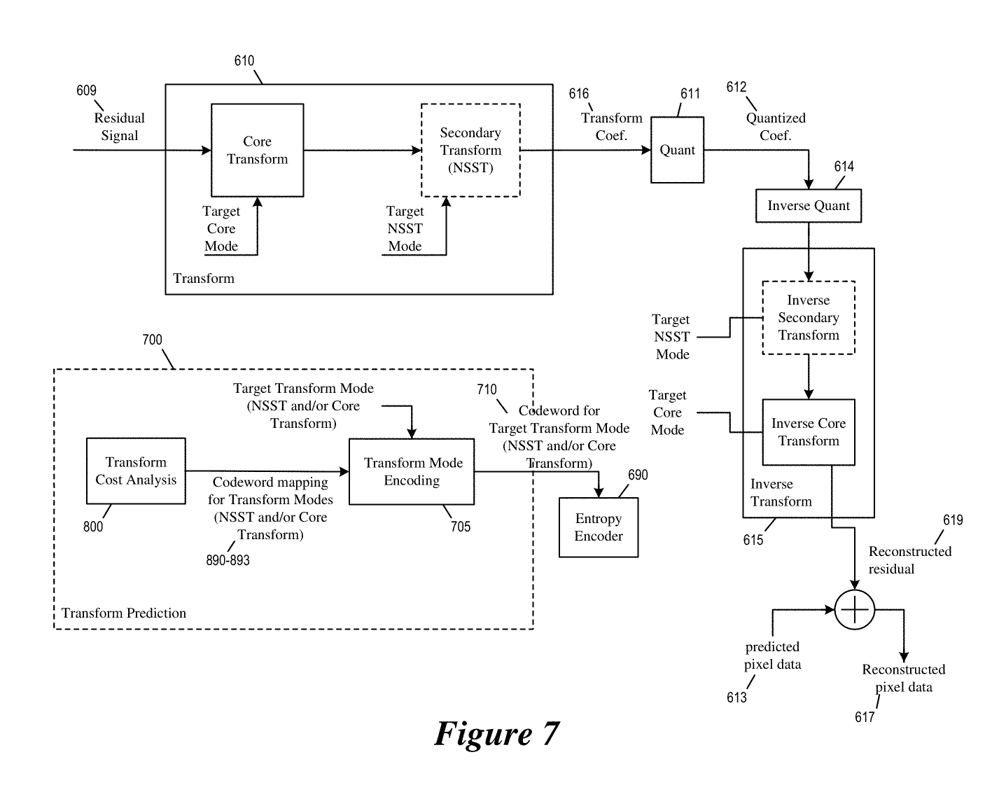

FIG. 7 illustrates portions of the encoder 600 that implements dynamic code word assignment for signaling selection from among multiple transforms. Specifically, the encoder 600 implements dynamic code word assignment for signaling the selection of core transform or secondary transform.

In one embodiment, the transform module 610 performs both core transform and secondary transform (NSST) on the residual signal 609, and the inverse transform module 615 performs corresponding inverse core transform and inverse secondary transform. The encoder 600 selects a core transform (target core mode) and a secondary transform (target NSST mode) for the transform module 610 and the inverse transform module 615. In another embodiment, the transform module 610 only performs core transform on the residual signal 609, and the inverse transform module 615 only performs corresponding inverse core transform. The encoder 600 selects a core transform (target core mode) for the transform module 610 and the inverse transform module 615.

In order to minimize the number of bits used for signaling the selection of the transforms for the current block, the encoder 600 includes a transform prediction module 700 that performs prediction that targets the core and/or secondary transforms that are used by transform module 610 and the inverse transform module 615. (The core and secondary transforms that are used for encode are therefore referred to as target transforms).

In some embodiments, when coding a block of pixels, the encoder 600 perform transform mode prediction for either NSST transform or core transform but not both. For example, the encoder 600 may perform transform prediction for signaling NSST mode selection but not for core mode selection when the current block is coded by intra-prediction. The encoder 600 may perform transform prediction for signaling core mode selection but not NSST mode selection when the current block is coded by inter-prediction. The encoder may perform transform prediction for NSST but not core transform for intra blocks of an intra slice. The encoder may perform transform prediction for core transform but not NSST for intra blocks of an inter slice.

When transform prediction is performed for signaling core transform. The transform prediction module 700 performs cost analysis for each of the candidate core transforms (e.g., DST-VII, DCT-VIII, DST-I and DCT-V.) Based on the cost analysis, the transform prediction module 700 assigns a code word to each of the candidate core transform. Based on the identity of the target core transform and the code words assigned to the candidate core transforms, the transform prediction module 700 identifies (at transform mode encoding 705) a code word 710 that is assigned to the matching candidate core transform. This code word 710 is provided to the entropy encoder 690 to signal the target core transform in the bitstream 695.

Likewise, when transform prediction is performed for signaling NSST, the transform prediction module 700 performs cost analysis for each of the candidate secondary (NSST) transform modes (NSST at different HyGT rotation angles or no NSST at all.) Based on the cost analysis, the transform prediction module 700 assigns a code word to each of the candidate secondary transform. Based on the identity of the target secondary transform and the code words assigned to the candidate secondary transforms, the transform prediction module 700 identifies (at transform mode encoding 705) a code word 720 that is assigned to the matching candidate secondary transform. This code word 720 is then provided to the entropy encoder 690 to signal the target secondary transform in the bitstream 695.

In some embodiments, the encoder performs transform mode prediction for NSST and core transform together. In other words, the transform prediction module 700 generates a code word for every possible combination of NSST and Core transform. The cost of every possible combination of NSST and Core transform is computed, and the shortest code word (i.e., ‘0’) will be assigned to the lowest cost combination of NSST and Core transform. Each combination of NSST and core transform can be regarded as one candidate transform mode, and the transform prediction module 700 compute costs and assign code words for N×M candidate transform modes, N being the number of possible NSST modes and M being the number of possible core transform modes.

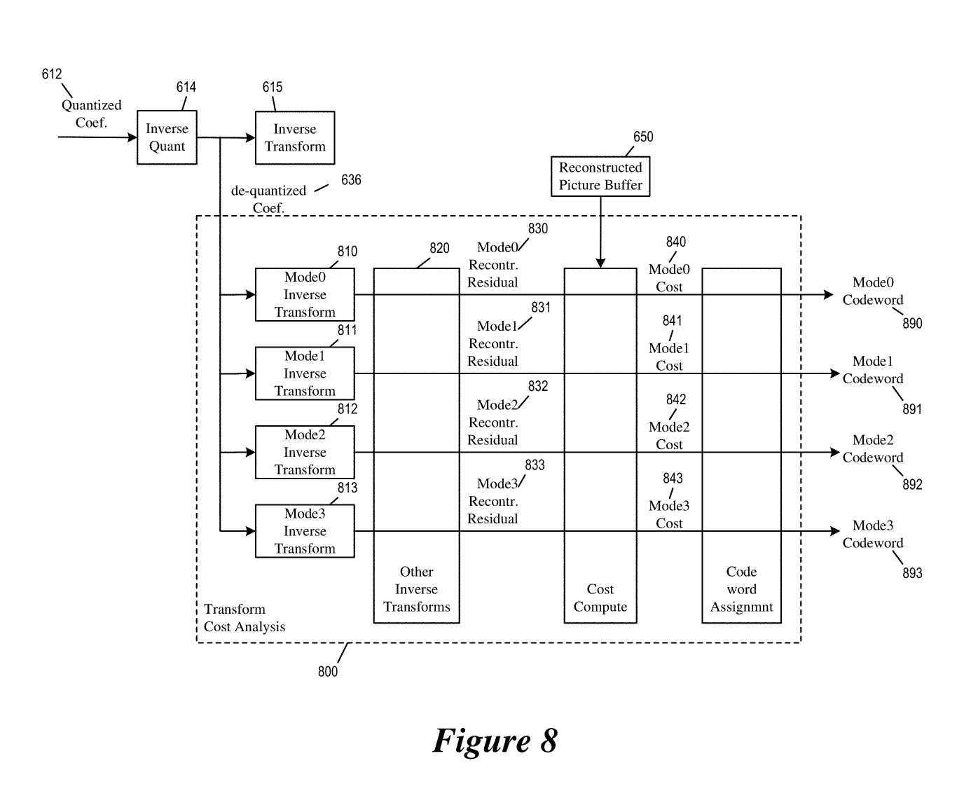

FIG. 8 conceptually illustrates the cost analysis and code word assignment operations performed by the transform prediction module 700. These operations are collectively illustrated in FIGS. 7 and 8 as being performed by a transform cost analysis module 800 in the transform prediction module 700.

As illustrated, the transform cost analysis module 800 receives the output of the inverse quantization module 614 for the current block, which includes the de-quantized transform coefficients 636. The transform cost analysis module 800 performs the inverse transform operations on the transform coefficients 636 based on each of the candidate transform modes (inverse transform 810-813 for mode 0-3, respectively). The transform cost analysis module 800 may further perform other requisite inverse transforms 820 (e.g., inverse core transform after each of the inverse secondary transforms). The result of each inverse candidate transform mode is taken as reconstructed residuals for that candidate transform mode (reconstructed residual 830-833 for mode 0-3, respectively). The transform cost analysis module 800 then computes a cost for each of the candidate transform modes (costs 840-843 for modes 0-3, respectively). The costs are computed based on the reconstructed residuals of the candidate transform modes and/or pixel values retrieved from the reconstructed picture buffer 650 (e.g., for the reconstructed pixels of neighboring blocks). The computation of cost of a candidate transform mode is described by reference to FIGS. 4 and 5 above.

Based on the result of the computed costs of the candidate transform modes, the transform cost analysis module 800 performs code word assignment and produces code word mappings 890-893 for each candidate transform modes. The mappings assign a code word to each candidate transform mode. The candidate transform mode with the lowest computed cost is chosen or identified as the predicted transform mode and assigned the shortest code word (e.g., the NSST transform mode 3 of FIG. 3), which reduces bit rate when the predicted transform matches the target transform. As mentioned earlier, the assignment of code words is based on an ordering of the different candidate transform modes, such ordering may be based on the computed costs or based on a predetermined table related to the chosen predicted transform such as rotation angles of HyGT.

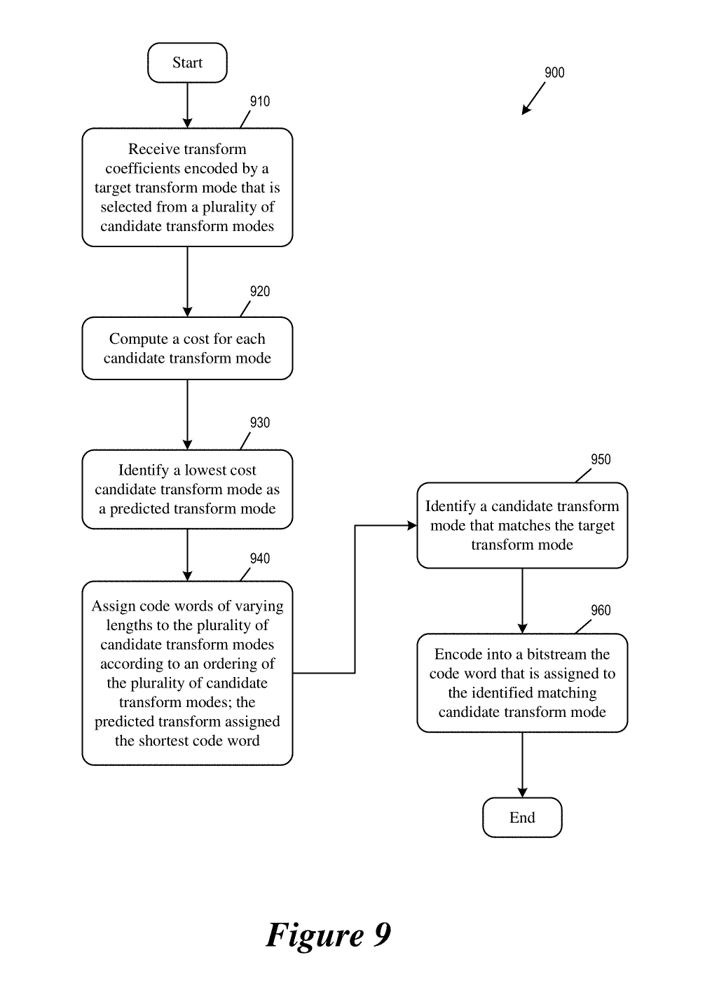

FIG. 9 conceptually illustrates a process 900 that signals selection of a transform from multiple candidate transforms by using dynamic code word assignment. In some embodiments, one or more processing units (e.g., a processor) of a computing device implementing the encoder 600 performs the process 900 by executing instructions stored in a computer readable medium. In some embodiments, an electronic apparatus implementing the encoder 600 performs the process 900. The encoder 600 performs the process 900 when it is encoding a current block of pixels in a video picture. The encoder may perform the process 900 when it is signaling a selection of a core transform mode or a secondary transform (e.g., NSST) mode.

The process 900 starts when the encoder 600 receives (at step 910) transform coefficients that are encoded (at the encoder 600) by a target transform mode that was used to encode the block of pixels. The target transform mode is selected from multiple candidate transform modes.

The encoder 600 computes (at step 920) a cost for each candidate transform mode. In some embodiments, the cost is computed by measuring the energy of the reconstructed residuals of each candidate transform. In some embodiments, the cost is computed by matching pixels of neighboring blocks with reconstructed pixels of each candidate transform. The encoder 600 also identifies (at step 930) a lowest cost candidate transform mode as a predicted transform mode.

The encoder 600 assigns (at step 940) code words of varying lengths to the multiple candidate transform modes according to an ordering of the multiple candidate transform modes. The ordering may be based on the computed costs of the candidate transform modes. The predicted transform mode is assigned the shortest code word.

The encoder 600 identifies (at 950) a candidate transform mode that matches the target transform mode. The encoder 600 encodes (at 960) into a bitstream the code word that is assigned to the identified matching candidate transform mode. The process 900 then ends.

### Example Video Decoder

FIG. 10 illustrates an example video decoder 1000 that uses dynamic code word assignment to receive selection of a transform from multiple candidate transforms. As illustrated, the video decoder 1000 is an image-decoding or video-decoding circuit that receives a bitstream 1095 and decodes the content of the bitstream into pixel data of video frames for output. The video decoder 1000 has several components or modules for decoding the bitstream 1095, including an inverse quantization module 1005, an inverse transform module 1015, an intra-picture prediction module 1025, a motion compensation module 1035, an in-loop filter 1045, a decoded picture buffer 1050, a MV buffer 1065, a MV prediction module 1075, and a bitstream parser 1090.

In some embodiments, the modules 1010-1090 are modules of software instructions being executed by one or more processing units (e.g., a processor) of a computing device. In some embodiments, the modules 1010-1090 are modules of hardware circuits implemented by one or more ICs of an electronic apparatus. Though the modules 1010-1090 are illustrated as being separate modules, some of the modules can be combined into a single module.

The parser 1090 (or entropy decoder) receives the bitstream 1095 and performs initial parsing according to the syntax defined by a video-coding or image-coding standard. The parsed syntax element includes various header elements, flags, as well as quantized data (or quantized coefficients) 1012. The parser 1090 parses out the various syntax elements by using entropy-coding techniques such as context-adaptive binary arithmetic coding (CABAC) or Huffman encoding.

The inverse quantization module 1005 de-quantizes the quantized data (or quantized coefficients) 1012 to obtain transform coefficients, and the inverse transform module 1015 performs inverse transform on the transform coefficients 1016 to produce reconstructed residual signal 1019. The reconstructed residual signal 1019 is added with prediction pixel data 1013 from the intra-prediction module 1025 or the motion compensation module 1035 to produce decoded pixel data 1017. The decoded pixels data are filtered by the in-loop filter 1045 and stored in the decoded picture buffer 1050. In some embodiments, the decoded picture buffer 1050 is a storage external to the video decoder 1000. In some embodiments, the decoded picture buffer 1050 is a storage internal to the video decoder 1000.

The intra-picture prediction module 1025 receives intra-prediction data from bitstream 1095 and according to which, produces the predicted pixel data 1013 from the decoded pixel data 1017 stored in the decoded picture buffer 1050. In some embodiments, the decoded pixel data 1017 is also stored in a line buffer (not illustrated) for intra-picture prediction and spatial MV prediction.

In some embodiments, the content of the decoded picture buffer 1050 is used for display. A display device 1055 either retrieves the content of the decoded picture buffer 1050 for display directly, or retrieves the content of the decoded picture buffer 1050 to a display buffer. In some embodiments, the display device receives pixel values from the decoded picture buffer 1050 through a pixel transport.

The motion compensation module 1035 produces predicted pixel data 1013 from the decoded pixel data 1017 stored in the decoded picture buffer 1050 according to motion compensation MVs (MC MVs). These motion compensation MVs are decoded by adding the residual motion data received from the bitstream 1095 with predicted MVs received from the MV prediction module 1075.

The MV prediction module 1075 generates the predicted MVs based on reference MVs that were generated for decoding previous video frames, e.g., the motion compensation MVs that were used to perform motion compensation. The MV prediction module 1075 retrieves the reference MVs of previous video frames from the MV buffer 1065. The video decoder 1000 stores the motion compensation MVs generated for decoding the current video frame in the MV buffer 1065 as reference MVs for producing predicted MVs.

The in-loop filter 1045 performs filtering or smoothing operations on the decoded pixel data 1017 to reduce the artifacts of coding, particularly at boundaries of pixel blocks. In some embodiments, the filtering operation performed includes sample adaptive offset (SAO). In some embodiment, the filtering operations include adaptive loop filter (ALF).

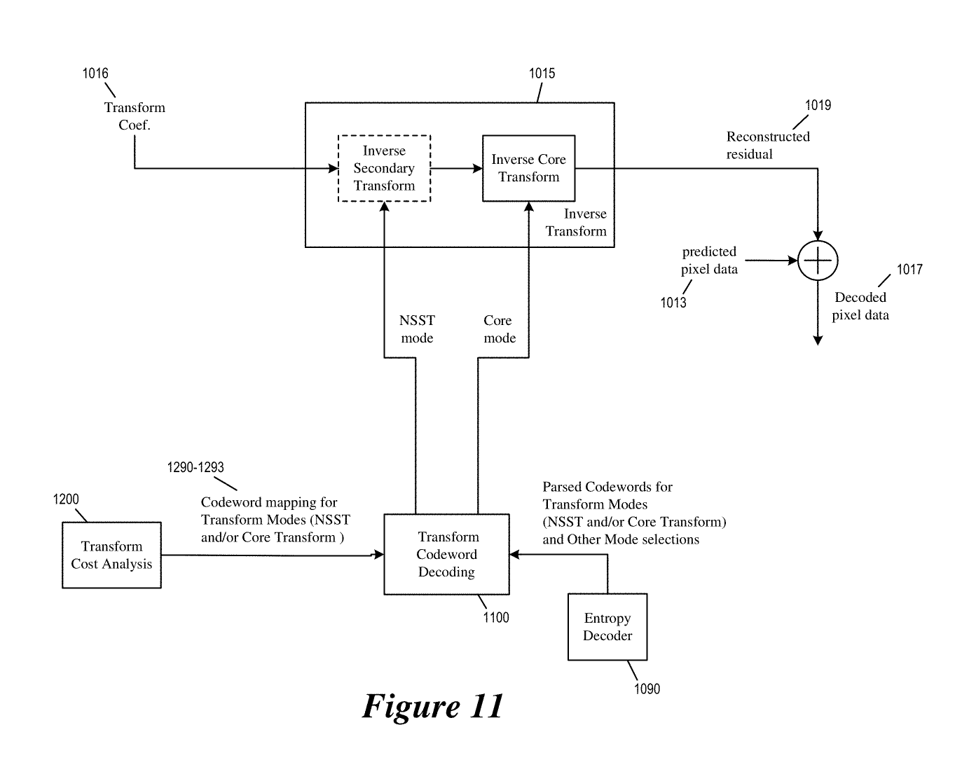

FIG. 11 illustrates portions of the decoder 1000 that implement dynamic code word assignment for receiving a selection of the core transform and a selection of the secondary transform.

The entropy decoder 1090 parses the bitstream 1095 and obtains a code word for core transform mode only, or a code word for core transform mode and a code word for secondary transform (NSST) mode that was used to encode the current block of pixels (i.e., the target transforms). A transform code word decoding module 1100 decodes the parsed code word(s) to identify the target core transform and/or the secondary transform. The inverse transform module 1015 then performs inverse transform operations according to the identified core and/or secondary transform modes.

In order to correctly decode the parsed code words for the target core and/or secondary transform modes, the decoder 1000 performs cost analysis of the different candidate transforms and produces code word mappings 1290-1293 for core and/or secondary transform modes. The mappings assign a code word to each candidate transform mode. In some embodiments, depending on whether the current block is intra-coded or inter-coded, or whether the current block is in an intra-slice or an inter-slice, the transform code word decoding module 1100 would using the code word mapping 1290-1293 to find a matching core transform or secondary transform based on the parsed code word. In some embodiments, each candidate transform may correspond to a combination of core and secondary transforms, and the transform code word decoding module 1100 would correspondingly map the parsed code word to a matching combination of core and secondary transforms. The identities of the matching core transform and secondary transform are provided to the inverse transform module 1015.

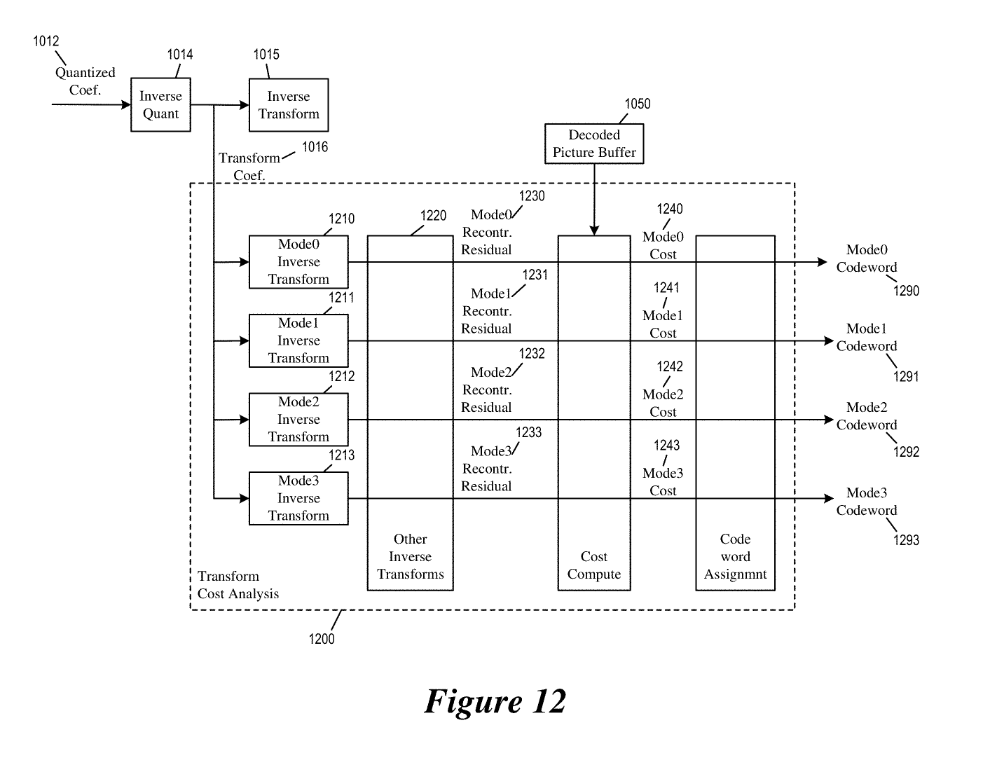

FIG. 12 conceptually illustrates the cost analysis and code word assignment operations performed for the transform code word decoding module 1100. These operations are collectively illustrated in FIGS. 11 and 12 as being performed by a transform cost analysis module 1200 in the decoder 1000.

As illustrated, the transform cost analysis module 1200 receives the output of the inverse quantization module 1014 for the current block, which includes the de-quantized transform coefficients 1016. The transform cost analysis module 1200 performs the inverse transform operations on the transform coefficients 1016 based on each of the candidate transform modes (inverse transform 1210-1213 for mode 0-3, respectively). The transform cost analysis module 1200 may further perform other requisite inverse transforms 1220 (e.g., inverse core transform after each of the inverse secondary transforms). The result of each inverse candidate transform mode is taken as reconstructed residuals for that candidate transform mode (reconstructed residual 1230-1233 for mode 0-3, respectively). The transform cost analysis module 1200 then computes a cost for each of the candidate transform modes (costs 1240-1243 for modes 0-3, respectively). The costs are computed based on the reconstructed residuals of the candidate transform modes and/or pixel values retrieved from the decoded picture buffer 1050 (e.g., for the decoded pixels of neighboring blocks). The computation of the cost of a candidate transform mode is described by reference to FIGS. 4 and 5 above.

Based on the result of the computed costs of the candidate transform modes, the transform cost analysis module 1200 performs code word assignment, which assigns a code word to each candidate transform mode (assigned code words 1290-1293 for mode 0-3, respectively). The candidate transform mode with the lowest computed cost corresponds to the predicted transform mode and assigned the shortest code. The assignment of code words is based on an ordering of the different candidate transform modes, such ordering may be based on the computed costs or a predetermined table related to the chosen predicted transform such as rotation angles of HyGT.

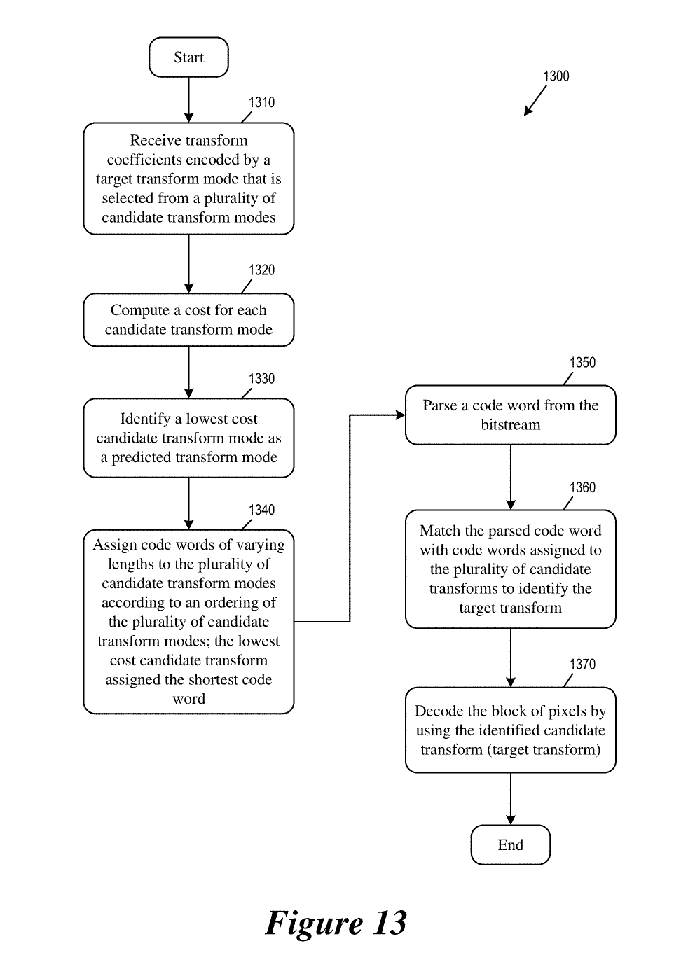

FIG. 13 conceptually illustrates a process 1300 that uses dynamic code word assignment to receive selection of a transform from multiple candidate transforms. In some embodiments, one or more processing units (e.g., a processor) of a computing device implementing the decoder 1000 performs the process 1300 by executing instructions stored in a computer readable medium. In some embodiments, an electronic apparatus implementing the decoder 1000 performs the process 1300. The decoder 1000 performs the process 1300 when it is decoding a current block of pixels of a video picture. The decoder may perform the process 1300 when it is parsing the bitstream 1095 and decoding a selection of a core transform mode or a secondary transform (e.g., NSST) mode.

The process 1300 starts when the decoder 1000 receives (at step 1310) transform coefficient encoded (at an encoder) by a target transform mode that was used to encode the block of pixels. The target transform mode is one of multiple candidate transform modes.

The decoder 1000 computes (at step 1320) a cost for each candidate transform mode. In some embodiments, the cost is computed by measuring the energy of the reconstructed residuals of each candidate transform (output of the inverse transform). In some embodiments, the cost is computed by matching pixels of neighboring blocks with reconstructed pixels of each candidate transform (sum of predicted pixels with reconstructed residuals). The decoder 1000 also identifies (at step 1330) a lowest cost candidate transform mode as a predicted transform mode.

The decoder 1000 assigns (at step 1340) code words of varying lengths to the multiple candidate transform modes according to an ordering of the multiple candidate transform modes. The ordering may be based on the computed costs of the candidate transform modes. The candidate transform mode with the lowest cost is assigned the shortest code word.

The decoder 1000 parses (at step 1350) a code word from the bitstream. The decoder 1000 matches (at step 1360) the parsed code word with the code words assigned to the candidate transform modes to identify the target transform. The decoder 1000 then decodes (at step 1370) the current block of pixels by using the identified candidate transform mode, i.e., performing inverse transform based on the identified target transform mode. The process 1300 then ends.

### Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

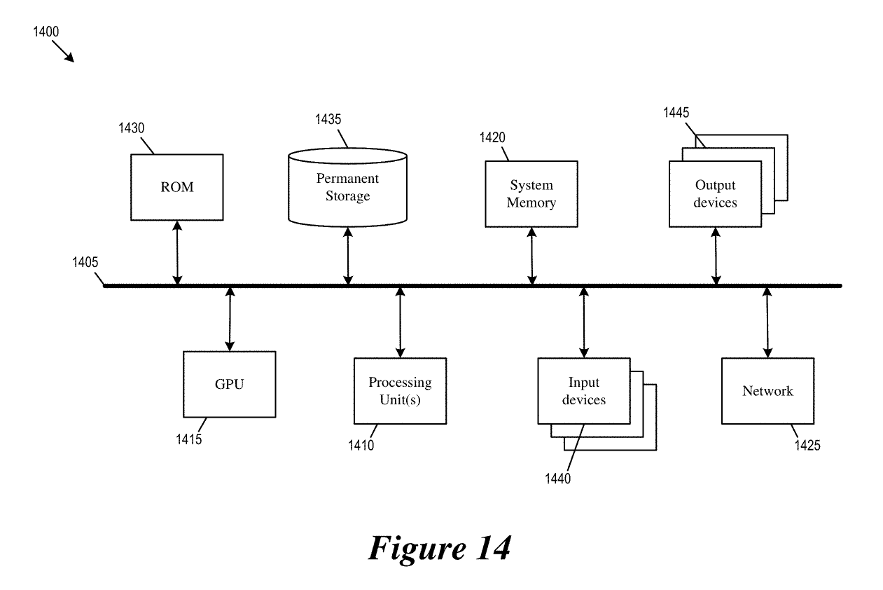

FIG. 14 conceptually illustrates an electronic system 1400 with which some embodiments of the present disclosure are implemented. The electronic system 1400 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1400 includes a bus 1405, processing unit(s) 1410, a graphics-processing unit (GPU) 1415, a system memory 1420, a network 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the GPU 1415, the read-only memory 1430, the system memory 1420, and the permanent storage device 1435.

From these various memory units, the processing unit(s) 1410 retrieves instructions to execute and data to process in order to execute the processes of the present disclosure. The processing unit(s) may be a single processor or a multi-core processor in different embodiments. Some instructions are passed to and executed by the GPU 1415. The GPU 1415 can offload various computations or complement the image processing provided by the processing unit(s) 1410.

The read-only-memory (ROM) 1430 stores static data and instructions that are needed by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the present disclosure use a mass-storage device (such as a magnetic or optical disk and its corresponding disk drive) as the permanent storage device 1435.

Other embodiments use a removable storage device (such as a floppy disk, flash memory device, etc., and its corresponding disk drive) as the permanent storage device. Like the permanent storage device 1435, the system memory 1420 is a read-and-write memory device. However, unlike storage device 1435, the system memory 1420 is a volatile read-and-write memory, such a random access memory. The system memory 1420 stores some of the instructions and data that the processor needs at runtime. In some embodiments, processes in accordance with the present disclosure are stored in the system memory 1420, the permanent storage device 1435, and/or the read-only memory 1430. For example, the various memory units include instructions for processing multimedia clips in accordance with some embodiments. From these various memory units, the processing unit(s) 1410 retrieves instructions to execute and data to process in order to execute the processes of some embodiments.

The bus 1405 also connects to the input and output devices 1440 and 1445. The input devices 1440 enable the user to communicate information and select commands to the electronic system. The input devices 1440 include alphanumeric keyboards and pointing devices (also called “cursor control devices”), cameras (e.g., webcams), microphones or similar devices for receiving voice commands, etc. The output devices 1445 display images generated by the electronic system or otherwise output data. The output devices 1445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 14, bus 1405 also couples electronic system 1400 to a network 1425 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIGS. 9 and 13) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method, comprising:
receiving transform coefficients of a block of pixel that are encoded by using a target transform mode that is selected from a plurality of candidate transform modes;
computing a cost for each candidate transform mode and identifying a lowest cost candidate transform mode as a predicted transform mode;
assigning code words of varying lengths to the plurality of candidate transform modes according to an ordering of the plurality of candidate transform modes, wherein the predicted transform mode is assigned a shortest code word;
identifying a candidate transform mode that matches the target transform mode and the corresponding code word assigned to the identified candidate transform mode; and
coding the block of pixels for transmission or display by using the identified transform mode.

2. The method of claim 1, wherein each transform mode in the plurality of candidate transform modes is a non-separable secondary transform (NSST) mode.

3. The method of claim 2, wherein the block of pixels is coded into a set of transform coefficients by a particular intra-coding mode, wherein the plurality of candidate transform modes are candidate transform modes that are mapped to the particular intra-coding modes.

4. The method of claim 1, wherein each transform mode in the plurality of candidate transform modes is a core transform.

5. The method of claim 1, wherein the ordering of the plurality of candidate transform modes is based on the computed costs for the plurality of candidate transform modes.

6. The method of claim 1, wherein the ordering of the plurality of candidate transform modes is based on a predetermined table that specifies the ordering based on relationships to the predicted transform mode.

7. The method of claim 1, wherein the cost associated with each candidate transform mode is computed by adaptively scaling or choosing transform coefficients of the block of pixels.

8. The method of claim 1, wherein the cost associated with each candidate transform mode is computed by adaptively scaling or choosing reconstructed residuals of the block of pixels.

9. The method of claim 1, wherein the cost associated with each candidate transform mode is determined by computing a difference between pixels of the block that are reconstructed from residuals of the block by the corresponding candidate transform mode and predicted pixels of the block, and pixels in spatially neighboring blocks, wherein the pixels of the block are reconstructed from residuals of the neighboring block and predicted pixels of the neighboring block.

10. The method of claim 9, wherein the transform coefficients associated with each candidate transform mode is adaptively scaled or chosen when reconstructing the residuals for the corresponding candidate transform mode.

11. The method of claim 9, wherein the reconstructed residuals of the block of pixels associated with each candidate transform mode is adaptively scaled or chosen when reconstructing the pixels for the corresponding candidate transform mode.

12. The method of claim 9, wherein the set of pixels of the block being reconstructed comprises pixels bordering the spatially neighboring blocks and not all pixels of the block.

13. The method of claim 1, wherein the cost associated with each candidate transform mode is determined by measuring an energy of reconstructed residuals of the block.

14. An electronic apparatus comprising:
a video encoder circuit capable of:
receiving transform coefficients that are encoded by using a target transform mode that is selected from a plurality of candidate transform modes;
computing a cost for each candidate transform mode and identifying a lowest cost candidate transform mode as a predicted transform mode;
assigning code words of varying lengths to the plurality of candidate transform modes according to an ordering of the plurality of the transform modes, wherein the predicted transform mode is assigned a shortest code word;
identifying a candidate transform mode that matches the target transform mode;
encoding into a bitstream the code word that is assigned to the identified matching candidate transform mode; and
storing or transmitting the encoded bitstream.

15. An electronic apparatus comprising:
a video decoder circuit capable of:
receiving transform coefficients that are encoded by using a target transform mode that is selected from a plurality of candidate transform modes;
computing a cost for each candidate transform mode and identifying a lowest cost candidate transform mode as a predicted transform mode;
assigning code words of varying lengths to the plurality of candidate transform modes according to an ordering of the plurality of the transform modes, wherein the predicted transform mode is assigned a shortest code word;
parsing a code word from a bitstream and matching the parsed code word with the code words assigned to the plurality of candidate transforms to identify the target transform mode;
decoding the block of pixels by using the identified target transform mode; and
outputting the decoded block of pixels.
